(19) United States
(12) Patent Application Publication
(10) Pub. No.: US 2012/0038839 A1
(43) Pub. Date: Feb. 16, 2012

(54) MICRO PROJECTOR MODULE

(75) Inventors: Yueh Ming TUNG, Kaohsiung County (TW); Chia Ming YANG, Tainan City (TW); Shu Hui LIN, Kaohsiung County (TW); Yuan Wei LIU, Kaohsiung County (TW); Wei Fang LIN, Kaohsiung City (TW)

(73) Assignee: ORIENT SEMICONDUCTOR ELECTRONICS, LIMITED, Kaohsiung (TW)

(21) Appl. No.: 12/899,870

(22) Filed: Oct. 7, 2010

(30) Foreign Application Priority Data
Aug. 13, 2010 (TW) 099215553

(51) Int. Cl. G02F 1/136; G02F 1/1347

(52) U.S. Cl. 349/5

(57) ABSTRACT

A micro projector module according to the present invention is provided. The micro projector module includes a substrate, a controller chip, a LCOS chip, a glass and a liquid crystal layer. The controller chip is positioned on the upper surface of the substrate and electrically connected to the substrate. The LCOS chip is positioned on the controller chip and electrically connected to the substrate. The glass is positioned on the LCOS chip and the liquid crystal layer is disposed between the LCOS chip and glass.

### CROSS REFERENCE TO RELATED APPLICATION

This application claims the priority benefit of Taiwan Patent Application Serial Number 099215553 filed Aug. 13, 2010, the full disclosure of which is incorporated herein by reference.

### BACKGROUND OF THE INVENTION

1. Field of the Invention

The invention relates to a micro projector module, and more particularly, to a micro projector module with a stacked structure.

2. Description of the Related Art

In general, the controller chip and LCOS chip of a conventional micro projector module are commonly arranged on different positions on a substrate. This will increase the production cost and decrease the available space on the substrate accordingly.

Accordingly, there exists a need to provide a solution to solve the above-mentioned problems.

### SUMMARY OF THE INVENTION

The present invention provides a micro projector module of which the LCOS chip is positioned on the controller chip package or directly on the unpackaged controller chip thereby increasing the available space on the substrate.

In one embodiment, the micro projector module of the present invention includes a substrate, a controller chip, a LCOS chip, a glass and a liquid crystal layer. The controller chip is positioned on the upper surface of the substrate and electrically connected to the substrate. The LCOS chip is positioned on the controller chip and electrically connected to the substrate. The glass is positioned on the LCOS chip and the liquid crystal layer is disposed between the LCOS chip and glass.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross-sectional view of the micro projector module according to the first embodiment of the present invention.

FIG. 2 is a top view of a substrate, wherein the substrate has a slot positioned thereon into which the micro projector modules of the present invention can be inserted.

FIG. 3 is a cross-sectional view of the micro projector module according to the second embodiment of the present invention.

FIG. 4 is a cross-sectional view of the micro projector module according to the third embodiment of the present invention.

FIG. 5 is a cross-sectional view of the micro projector module according to the fourth embodiment of the present invention.

### DETAILED DESCRIPTION OF THE PREFERRED EMBODIMENT

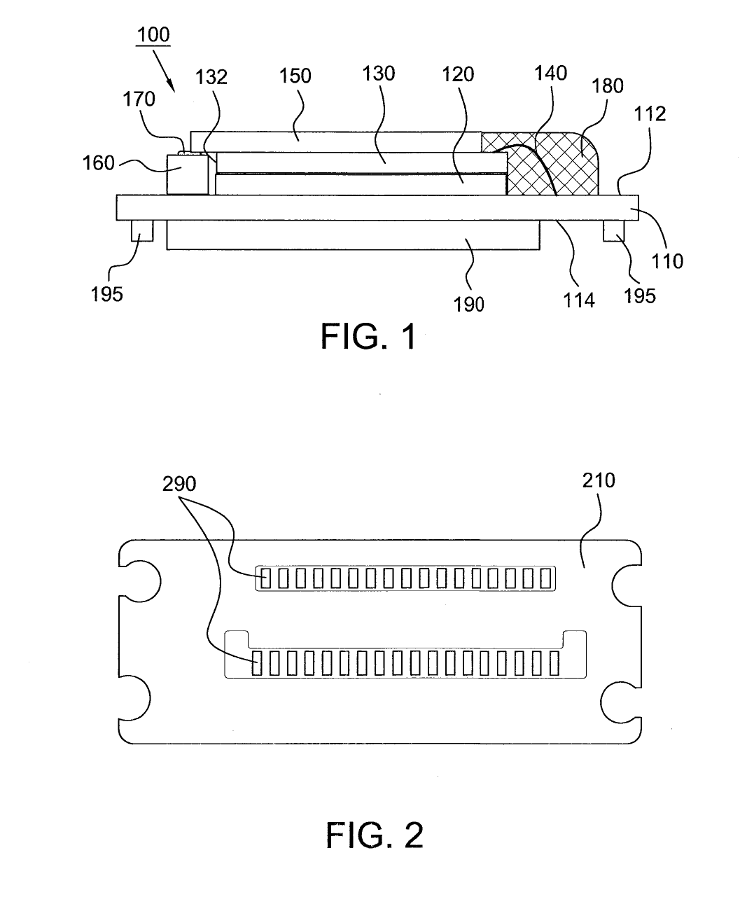

Referring to FIG. 1, the micro projector module 100 according to the first embodiment of the present invention includes a substrate 110 and a controller chip package 120 is positioned on the upper surface 112 of the substrate 110 and electrically connected to the substrate 110. In this embodiment, the controller chip package 120 can be a land grid array (LGA) package, ball grid array (BGA) package, quad flat non-leaded (QFN) package or other type packages. A liquid crystal on silicon (LCOS) chip 130 is attached to the controller chip package 120 by adhesive. A plurality of bonding wires 140 is used to electrically connect the LCOS chip 130 to the substrate 110. In order to prevent the bonding wires 140 from damage, a sealant 180 is formed on the upper surface 112 of the substrate 110 to encapsulate the bonding wires 140. A transparent glass 150 is positioned on the LCOS chip 130 and protrudes from an edge 132 of the LCOS chip 130. A liquid crystal layer is disposed between the glass 150 and LCOS chip 130 (not shown in the figure). In addition, a conductive block 160 is formed under the glass 150 and aside the edge 132 of the LCOS chip 130. A conductive adhesive 170 is formed on the conductive block 160 to electrically connect the glass 150 to the conductive block 160.

In order to enable the controller chip package 120 to electrically connect to external circuitry, a connector 190 is positioned on the lower surface 114 of the substrate 110. The connector 190 can be inserted into, for example, the slot 290 on the substrate 210 of FIG. 2. In addition, a plurality of passive components 195 is positioned on the lower surface 114 of the substrate 110 to enable the micro projector module 100 to function well.

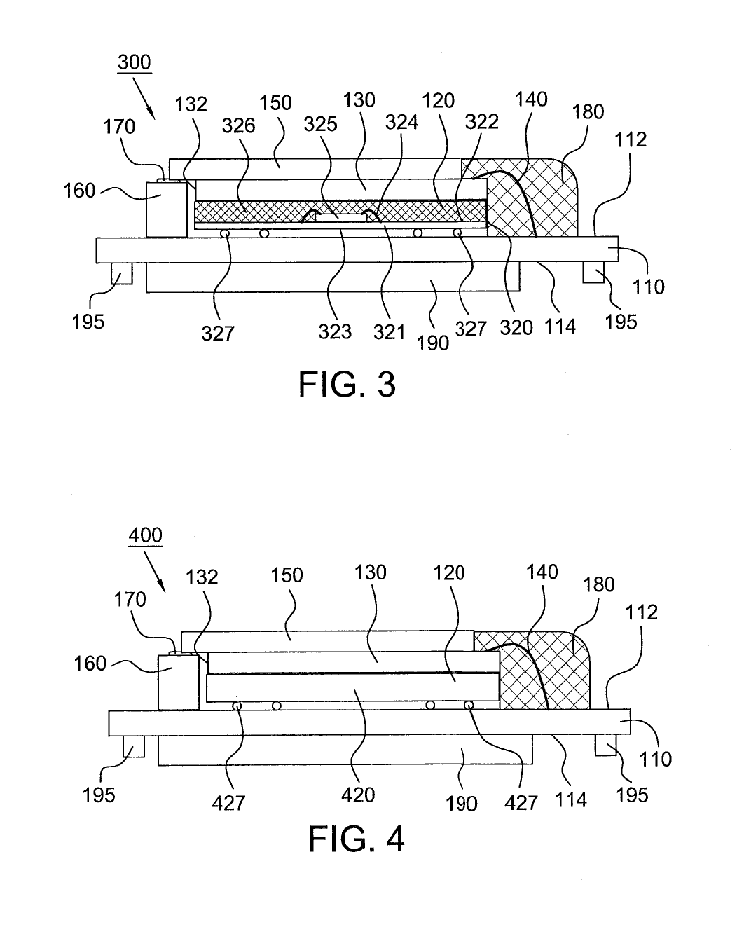

Referring to FIG. 3, the micro projector module 300 according to the second embodiment of the present invention is similar to the micro projector module 100 according to the first embodiment of the present invention, where identical reference numerals have been used when designating substantially identical elements that are common to the figures. The differences between them are in that the micro projector module 300 has a controller chip package 320 that is a wire-bonding type package. More specifically, the controller chip package 320 includes a substrate 321 and a controller chip 325 is attached to the upper surface 322 of the substrate 321 by adhesive. A plurality of bonding wires 324 electrically connects the controller chip 325 to the substrate 321. A sealant 326 is formed on the upper surface 322 of the substrate 321 to encapsulate the controller chip 325 and bonding wires 324. In addition, a plurality of metal bumps 327, such as solder balls is positioned on the lower surface 323 of the substrate 321 to electrically connect the controller chip 325 to the substrate 110. Furthermore, because the other elements of the micro projector module 300 and their connecting relations are the same as those of the micro projector module 100, any further illustrations of the micro projector module 300 are omitted herein.

Referring to FIG. 4, the micro projector module 400 according to the third embodiment of the present invention is similar to the micro projector module 100 according to the first embodiment of the present invention, where identical reference numerals have been used when designating substantially identical elements that are common to the figures. The differences between them are in that the micro projector module 400 has a controller chip 420 that is not packaged in advance. Instead, the controller chip 420 is flip-chip bonded on the substrate 110. A plurality of metal bumps 427, such as solder balls is used to electrically connect the controller chip 420 to the substrate 110. The LCOS chip 130 is then attached to the backside of the controller chip 420. Furthermore, because the other elements of the micro projector module 400 and their connecting relations are the same as those of the micro projector module 100, any further illustrations of the micro projector module 400 are omitted herein.

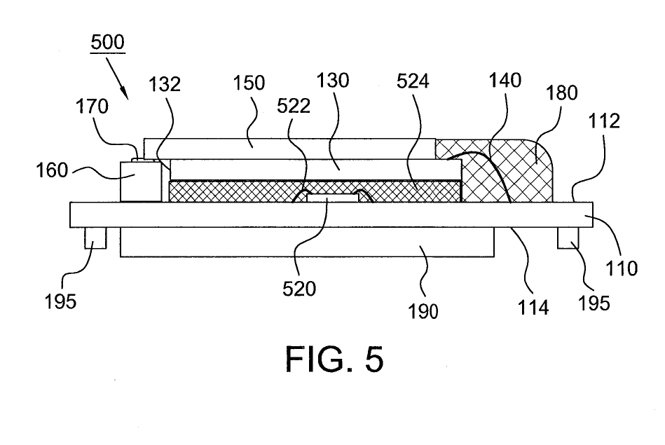

Referring to FIG. 5, the micro projector module 500 according to the fourth embodiment of the present invention is similar to the micro projector module 100 according to the first embodiment of the present invention, where identical reference numerals have been used when designating substantially identical elements that are common to the figures. The differences between them are in that the micro projector module 500 has a controller chip 520 that is bonded on the upper surface 112 of the substrate 110 by COB technique. More specifically, the unpackaged controller chip 520 is attached to the upper surface 112 of the substrate 110 by adhesive and a plurality of bonding wires 522 is used to electrically connect the controller chip 520 to the substrate 110. A sealant 524 is formed on the upper surface 112 of the substrate 110 to encapsulate the controller chip 520 and bonding wires 522. The LCOS chip 130 is then attached to the sealant 524. Furthermore, because the other elements of the micro projector module 500 and their connecting relations are the same as those of the micro projector module 100, any further illustrations of the micro projector module 500 are omitted herein.

According to the micro projector module of the present invention, the LCOS chip is positioned on the controller chip package or directly on the unpackaged (bare) controller chip thereby increasing the available space on the substrate.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A micro projector module, comprising:
a substrate having opposing upper and lower surfaces;
a controller chip positioned on the upper surface of the substrate and electrically connected to the substrate;
a LCOS chip positioned on the controller chip and electrically connected to the substrate;
a glass positioned on the LCOS chip; and
a liquid crystal layer disposed between the glass and the LCOS chip.

2. The micro projector module as claimed in claim 1, wherein the controller chip is flip-chip bonded on the substrate, the micro projector module further comprises:
a plurality of bumps electrically connecting the controller chip to the substrate.

3. The micro projector module as claimed in claim 1, further comprising:
a plurality of bonding wires electrically connecting the LCOS chip to the substrate; and
a sealant encapsulating the bonding wires.

4. The micro projector module as claimed in claim 1, further comprising:
a conductive block formed on the upper surface of the substrate; and
a conductive adhesive formed on the conductive block to electrically connect the conductive block to the glass.

5. The micro projector module as claimed in claim 4, further comprising:
a connector positioned on the lower surface of the substrate.

6. The micro projector module as claimed in claim 5, further comprising:
a plurality of passive components positioned on the lower surface of the substrate.

7. A micro projector module, comprising:
a substrate having opposing upper and lower surfaces;
a controller chip bonded on the upper surface of the substrate;
a plurality of first bonding wires electrically connecting the controller chip to the substrate;
a first sealant encapsulating the controller chip and the first bonding wires;
a LCOS chip positioned on the first sealant and electrically connected to the substrate;
a glass positioned on the LCOS chip; and
a liquid crystal layer disposed between the glass and the LCOS chip.

8. The micro projector module as claimed in claim 7, further comprising:
a plurality of second bonding wires electrically connecting the LCOS chip to the substrate; and
a second sealant encapsulating the second bonding wires.

9. The micro projector module as claimed in claim 7, further comprising:
a conductive block formed on the upper surface of the substrate; and
a conductive adhesive formed on the conductive block to electrically connect the conductive block to the glass.

10. The micro projector module as claimed in claim 9, further comprising:
a connector positioned on the lower surface of the substrate.

11. The micro projector module as claimed in claim 10, further comprising:
a plurality of passive components positioned on the lower surface of the substrate.

12. A micro projector module, comprising:
a first substrate having opposing upper and lower surfaces;
a controller chip package positioned on the upper surface of the first substrate and electrically connected to the first substrate;
a LCOS chip positioned on the controller chip package and electrically connected to the first substrate;
a glass positioned on the LCOS chip; and
a liquid crystal layer disposed between the glass and the LCOS chip.

13. The micro projector module as claimed in claim 12, further comprising:
a plurality of first bonding wires electrically connecting the LCOS chip to the first substrate; and
a first sealant encapsulating the first bonding wires.

14. The micro projector module as claimed in claim 12, wherein the controller chip package comprises:
a second substrate having opposing upper and lower surfaces;
a controller chip positioned on the upper surface of the second substrate;
a plurality of second bonding wires electrically connecting the controller chip to the second substrate; and
a second sealant encapsulating the controller chip and the second bonding wires.

15. The micro projector module as claimed in claim 12, further comprising:
a conductive block formed on the upper surface of the first substrate; and
a conductive adhesive formed on the conductive block to electrically connect the conductive block to the glass.

16. The micro projector module as claimed in claim 15, further comprising:
a connector positioned on the lower surface of the first substrate.

17. The micro projector module as claimed in claim 16, further comprising:
a plurality of passive components positioned on the lower surface of the first substrate.

18. The micro projector module as claimed in claim 14, further comprising:
a plurality of bumps formed on the lower surface of the second substrate and electrically connected to the first substrate.

19. The micro projector module as claimed in claim 14, wherein the controller chip package is a land grid array package.

20. The micro projector module as claimed in claim 14, wherein the controller chip package is a quad flat non-leaded package.
